(19) United States
(12) Patent Application Publication
(10) Pub. No.: US 2007/0208139 A1
(43) Pub. Date: Sep. 6, 2007

(54) Weldable thermoplastic sheet compositions

(76) Inventors: Ralph Edward Raulie, Akron, OH (US); Purushottam Das Agrawal, Akron, OH (US); Narayanaswami Raja Dharmarajan, Houston, TX (US); Michael Glenn Williams, Humble, TX (US); Sudhin Datta, Houston, TX (US)

Correspondence Address: ExxonMobil Chemical Company;Law Technology, P.O. Box 2149, Baytown, TX, 77522-2149, US

(21) Appl. No.: 11/366,906

(22) Filed: Mar. 2, 2006

(51) Int. Cl. C08L 23/04

(52) U.S. Cl. 525/240

(57) ABSTRACT

This disclosure in certain embodiments relates to thermoplastic sheet compositions and applications incorporating such materials. More specifically this disclosure addresses thermoplastic sheets comprising: a) from 5 to 98.5 wt % of an essentially uncross-linked, random ethylene copolymer having from 20 wt % to 90 wt % repeat units from ethylene and from 10 wt % to 80 wt % of repeat units from one or more other ethylenically unsaturated monomers based upon the weight of the random ethylene copolymer; b) from 0.3 to 83.5 wt % of a polypropylene-based thermoplastic; and c) from 0.3 to 24.5 wt % of a vulcanized rubber dispersed phase. The disclosure also relates to methods of making the sheet compositions. One method includes incorporating a thermoplastic vulcanizate to provide the c) vulcanized rubber and in come cases, to supplement the b) polypropylene thermoplastic. Another method relates to melt blending polymer blends in appropriate proportions in the presence of a curing agent to effect dynamic vulcanization of a cross-linkable rubber component. Improved welding characteristics and weld strength of the sheets and reduced blocking in the extrusion step of producing the sheets is achieved.

### BACKGROUND

This application relates to thermoplastic sheets or membranes suitable for use in applications where welding to other such sheets or membranes, or other substrates, is practiced. For example, composites of said sheets or membranes can be formed for use as roofing sheet materials where initial ease of welding, environmental stability and case of replacement are important factors in the selection and design of the sheets.

Numerous polymer-based materials have been developed and used in applications requiring welding of the material to other materials or to itself. Such applications include, but are not limited to, roofing membranes, bridge and parking deck liners, pond and swimming pool liners, basement water barriers, landfill containment liners, geomembranes, commercial tenting, truck tarps, pillow tanks, expansion joints, reservoir covers, hoses, wire and cable coatings. In roofing applications, welding of single-ply polymeric membranes lends it to easy installation eliminating the need for expensive adhesive tapes that are often required if the membranes are not weldable. Furthermore, installation is less affected by ambient conditions, less labor is required, and the installation is a simpler process in terms of procedure, faster speeds, fewer stops, and less chance of error. The membrane is a homogenous monolithic surface where there is no need for surface priming, which eliminates VOC's (“volatile organic components”) resulting in reduced chemical exposure to workers and an overall “green” product.

For roofing and other sheeting applications, the products are typically manufactured as calendared membrane sheets having a typical width of 10 feet (3 meters) or greater, although smaller widths may be available. The sheets are typically sold, transported, and stored in rolls. For roofing membrane applications, several sheets are unrolled at the installation site, placed adjacent to each other with an overlapping edge to cover the roof and are sealed together during installation. The sheets must be continuously and tightly sealed along the overlapping regions. After installation, the materials are exposed during service to various conditions that may deteriorate or destroy the integrity of the seal at the seams. For example, in roofing applications, the seams are subjected to adverse weather conditions such as moisture, high winds, sunlight, and extreme temperature changes.

Traditionally, these membranes comprised two types, elastomeric and thermoplastic. An elastomeric membrane is a vulcanized ethylene-propylene-diene terpolymer (“EPDM”). A conventional thermoplastic material is a plasticized PVC membrane.

Vulcanized EPDM has outstanding resistance to outdoor weathering, good flexibility at cold temperatures, high strength and excellent elongation. A disadvantage is the necessity of using adhesives for sealing the membrane seams to provide a continuous leak-free covering. See for example, U.S. Pat. No. 3,801,531 and U.S. Pat. No. 3,867,247. Such adhesives are expensive to apply, and also involve the use of volatile hydrocarbon solvents to prepare the surface, which poses environmental issues.

Another approach for seaming vulcanized roof sheets involves the use of a “tie layer” material (e.g., tape) that is inserted between the ends of the sheets and seamed in place by applying heat. U.S. Pat. No. 5,260,111 discloses a heat seamable thermoplastic tape for roofing applications. However, these tapes lose their seam integrity at higher operating temperatures seen on a rooftop resulting in poor adhesion and loss of seam integrity properties.

In recent years, thermoplastic olefin compounds (TPO's) were used increasingly in heat-weldable formulations. Thermoplastic olefin compositions have been used in applications such as single ply roofing, geomembranes, pond liners, and various specialty applications. Factors such as low cost, ease of installation through heat welding and environmental acceptance resulted in double-digit annual percentage growth rates for such thermoplastic olefin products.

Many thermoplastic olefin formulations were developed using blends of materials such as metallocene catalyst derived high crystallinity ethylene-octene plastomers and isotacetic polypropylene resins. These formulations are found to have sufficient flexibility, good physical properties and processability. However, the heat welding characteristics of the high crystallinity ethylene-octene plastomers are poor with, resulting in low peel strength upon heat welding. Furthermore, when these thermoplastic olefin compositions are aged in high temperature conditions, and then heat welded, the membranes display even lower and inadequate peel strength. For certain applications, heat-weldable formulations demonstrate adequate heat properties when aged in their non-reinforced state at 110° C. for periods up to 2 weeks or more in some applications. Formulations based primarily on a high-crystalline metallocene plastomer will soften at these temperatures within 30 minutes, because the test temperatures are above the crystalline melting point of the plastomers.

Compared to the vulcanized EPDM and plasticized PVC, thermoplastic olefins, and other thermoplastic materials offer surer seams because the material, being thermoplastic, can either be heat-sealed or solvent-welded to provide an integral seam without using additional adhesive materials. However, these membranes tend to lose plasticizer with time, which diminishes mechanical properties, resulting in shortened useful life and poor cold crack resistance.

Thermoplastic membranes may include components in the membrane formulations designed to promote adhesion between adjoining membrane sheets. WO 02/051928 discloses a composite polymer structure in which a first polymer is adhered to and is in surface contact with a second polymer structure by adhesive interface between the first polymer structure and the second polymer structure. Interfacial adhesion is provided by a semi-crystalline random copolymer in the first polymer structure, in the second polymer structure, and in a third adhesive layer, if used.

### BRIEF DESCRIPTION

One aspect of the invention is directed to thermoplastic sheets comprising: a) from 5 to 98.5 wt % of an essentially uncross-linked, random ethylene copolymer having from 20 wt % to 90 wt % repeat units from ethylene and from 10 wt % to 80 wt % of repeat units from one or more other ethylenically unsaturated monomers based upon the weight of the random ethylene copolymer; b) from 0 to 83.5 wt % of a polypropylene-based thermoplastic; c) from 0.3 to 24.5 wt % of a vulcanized rubber dispersed phase; and d) from 1-74 wt % conventional additives.

Another aspect of the invention is directed to a first method comprising: (a) combining (i) from 5.5 wt % to 98.5 wt % of a random ethylene copolymer having from 20 wt % to 90 wt % repeat units from ethylene and from 10 wt % to 80 wt % of repeat units from one or more other ethylenically unsaturated monomers based upon the weight of the random ethylene polymer, (ii) from 1 wt % to 42 wt % of a thermoplastic elastomer having a polypropylene thermoplastic phase and a vulcanized rubber dispersed phase, (iii) from 0 wt % to 50 wt % of an additional polypropylene component selected from the group consisting of one or more of a crystalline polypropylene homopolymer, impact copolymer polypropylene, and propylene α-olefin copolymer having an isotacetic polypropylene crystallinity of from 2 to 65% as measured by DSC, and (iv) from 0.5-60 wt % conventional additives; (b) melt processing the blend of (a) at a temperature higher than the melting temperature of the polypropylene; and, (c) extruding the melt processed blend of (b) as a thermoplastic sheet.

Yet another aspect of the invention is directed to a method comprising: (a) combining (i) from 5 wt % to 98.5 wt % of a random ethylene polymer essentially incapable of cross-linking in the presence of the crosslinking agent of step (b) and having from 20 wt % to 90 wt % repeat units from ethylene and from 10 wt % to 80 wt % of repeat units from one or more other ethylenically unsaturated monomers based upon the weight of the random ethylene polymer, (ii) from 0.3 wt % to 83.5 wt % of a polypropylene component, (iii) from 0.3 wt % to abut 24.5 wt % of an uncured rubber component capable of cross-linking in the presence of the cross-linking agent of step (b), and (iv) from 1-74 wt % conventional additives; (b) melt processing the blend of (a) at a temperature higher than the melting temperature of the polypropylene component (ii) in the presence of a cross-linking agent to form a thermoplastic composition containing a dispersed vulcanized rubber phase; (c) extruding the melt processed blend of (b) as a thermoplastic sheet.

The sheet compositions of the invention are found to have beneficial properties including a good balance of flexibility, physical properties, and weld strength performance. The compositions may also reduce blocking in materials made from the compositions.

### BRIEF DESCRIPTION OF THE DRAWING

FIG. 1 is a graphical representation of relative weld strength performance of the welded roofing sheet compositions of Table IV that have been weathered under atmospheric conditions over a period of time and then hot air welded. This graph is normalized on Weld Strength (Unaged/Aged welded roof sheet).

### DETAILED DESCRIPTION

This disclosure relates to thermoplastic sheets or membrane compositions having useful properties including beneficial weld strength, anti-blocking, and other physical characteristics. Although the compositions are weldable, this disclosure relates the compositions in general, regardless of the weldable nature of the compositions. Additional advantages of the compositions described herein are improved puncture performance, flexibility, self-healing or resealing performance, and inhibition of additive migration. “Weldable” means that the compositions are capable of being welded to themselves or to other materials thorough the application of heat to the composition or generation of heat within the composition; preferably, “weldable” refers to the ability to adhere at least two separate sheets or membranes of compositions to one another without the use of adhesives or other secondary compositions by such means as by melt-joining (“weld”). Exemplary techniques for creating welds of the compositions include, but are not limited to, traditional contact heat-welding techniques, hot air application techniques, vibration welding, ultrasonic welding, radio frequency (RF) welding, and laser welding.

Thus, a particular aspect of the invention is directed to a thermoplastic membrane comprising at least two welded sheets, wherein at least one of the two welded sheets comprises from 5 to 98.5 wt % of an essentially uncross-linked, random ethylene copolymer; from 0.3 to 83.5 wt % of a polypropylene-based crystalline thermoplastic; and from 0.3 to 24.5 wt % of a vulcanized rubber. The various embodiments of each of these components are described herein. In a preferred embodiment, both or all of the sheets comprise the same components in varying weight percentages; in a most preferred embodiment, both or all of the sheets comprise the same components in the same weight percentages. The at least two sheets are “welded” by any technique known in the art.

The compositions are sheets or membranes as described above. The membranes may have a thickness of 0.02 mm to 4.0 mm. Additionally, membranes for roofing, tarp, or tenting applications may be supported with polyester, polypropylene or other material reinforced fabric that is a scrim within the membrane and is typically 1 mil (0.025 mm) thick. However, other applications may not require a scrim reinforced membrane and these membranes are referred to as unsupported.

In one aspect of this invention, the weldable thermoplastic compositions described herein are multi-phased blends of at least three polyolefin components with at least one component forming a continuous matrix phase and with at least one of the other two components dispersed throughout the continuous matrix as a dispersed phase. The three components are at least one polypropylene component, at least one uncured ethylene copolymer component, and at least one cured rubber component. Any of the three components may form the continuous phase, including two in a co-continuous phase, although typically the cured rubber component forms an amorphous dispersed phase.

The “uncured elastomeric component” described herein may comprise, or consist essentially of, ethylene copolymers of ethylene and higher α-olefins with densities ranging from 0.860 to 0.920 g/cm³, and a melt index (“MI”, 2.16 kg/190° dg/min, ASTM-D1238), of 1.0 to 30, preferably 1.0 to 16. These copolymers are referred to as “plastomers”, because they possess mechanical and melt processing properties that are intrinsic to both a plastic and an elastomer. In a further embodiment, the density ranges from 0.87 g/cm³ to 0.910 g/cm³. In the compositions of the invention these copolymers are essentially uncross-linked (uncured), meaning that less than 5 wt % gel, based upon the weight of the uncured component, preferably less than 2 wt %, and even less than 1 wt % is formed in the presence to conventional rubber cross-linking or curing agents.

Plastomers are random copolymers in terms of the incorporation of the comonomer(s) in the polymer backbone. The thermoplastic random copolymer of ethylene and higher α-olefin used in the heat-weldable thermoplastic compositions described herein have molecular weight distributions (Mw/Mn) of from 1.5 or 1.7 to 3.5, more desirably from 1.8 to 3.0 and preferably from 1.5 or 1.9 to 2.8 due to the use of single site catalyst, as exemplified by metallocene catalysts that may be used to synthesize such polymers. The thermoplastic random copolymers of ethylene can have varying amounts of one or more comonomers therein in sufficient amounts to disrupt polyethylene crystallinity in varying degrees.

In one embodiment, the amount of ethylene in the random ethylene polymer is from 40 wt % to 95 wt %. In another embodiment, the ethylene content is from 65 wt % to 90 wt %. In another embodiment, the ethylene content is from 65 wt % to 85 wt %. The balance of the random ethylene polymer in each embodiment is derived form one or more comonomers that may be any ethylenically unsaturated comonomer copolymerizable with ethylene. The one or more ethylenically unsaturated monomers have from 3 to 12 carbon atoms. In another embodiment, the monomers have from 3 to 8 carbon atoms. In one embodiment, the monomers are preferably mono-olefins with the specified range of carbon atoms. Exemplary comonomers include mono-olefins such as propylene, butene, hexene, and octene.

Since a single site catalyst polymerization system, such as metallocene catalysts, readily incorporates comonomers with the ethylene in the thermoplastic random polymer of ethylene, the comonomers are randomly distributed within the individual polymer chains and the individual polymer chains are significantly uniform in comonomer composition. Due to the uniform distribution of the comonomer within the polymer chains and the uniformity of comonomer distribution within the polymer, as opposed to conventional polyethylene polymers made with a traditional Ziegler-Natta catalyst, the random ethylene polymers tend to have rather narrow melting temperature ranges as measured by testing methods such as dynamic scanning calorimetry (DSC) as compared to conventional ethylene polymers. This is due to the fact that the thermoplastic random polymers of ethylene have a very uniform crystalline structure and thus melt within a narrow temperature range. The peak represents the largest amount of endothermic crystal melting at a single temperature. Therefore, desirably the random polymer of ethylene has a peak melting temperature of less than 115° C. In one embodiment, the peak melting temperature ranges from 45° C. to 100° C. In another embodiment, the peak melting temperature ranges from 60° C. to 110° C. In still another embodiment, the peak melting temperature ranges from 65° C. to 100° C. Alternatively stated, the uncured polymeric component will typically have a crystallinity of at least 7% as measured by differential scanning calorimetry.

Exemplary uncured ethylene copolymer component materials suitable for use in the sheet compositions described here are ethylene-octene copolymers available from ExxonMobil Chemical (Houston, Tex.) under the designation EXACT® or from DuPont Dow Elastomers L.L.C. (Wilmington, Del.) under the designation ENGAGE®.

In one embodiment, the at least one uncured elastomeric component concentration in the formulations described herein ranges from 5 wt % to 98.5 wt % of the formulations in one embodiment. In another embodiment, the at least one uncured elastomeric component concentration ranges from 15 wt % to 75 wt % of the formulations. In still another embodiment, the at least one uncured elastomeric component concentration ranges from 20 wt % to 60 wt % of the formulations.

The uncured elastomeric component may additionally comprise one or more olefin rubber component, the ethylene-propylene rubber (“EPR”) compositions being most suitable. The EPR typically comprises ethylene, propylene, and, optionally, one or more C₄-C₂₀ α-olefin or diolefin. It will typically have a density of from 0.85 to 0.88 g/cm and will typically have a Mooney viscosity (M_{L}(1+4@125° C.)) of 20 to 450, more preferably from 50 to 400, and most preferably from 200 to 400. Such may be provided directly as such from commercial or industrial sources, as noted for the olefin rubbers of the TPV component, or may be contributed as a portion of one of the other components prepared by coordination polymerization of ethylene and propylene. Since this rubber component is comprised in the uncured elastomer component, it is not be cross-linkable to any great degree in the presence of residual curing agent of the TPV component (see below), or in the alternative method where the cured rubber phase is provided by a dynamic vulcanization of the total blend composition not comprising the preformed TPV (also see below). Thus diolefin comonomers will be largely avoided unless in the first instance the residual curative in the TPV is insignificant in amount, e.g., less than 0.05 wt % based upon the total weight of vulcanized rubber in the TPV. In a preferred embodiment, the EPR in this uncured phase does not exceed the gel content limitations noted for the uncured plastomer component above. The EPR component may thus constitute up to 50 wt % of the uncured elastomer phase, preferably less than 35 wt %, more preferably less than 20 wt %, or even less than 5 wt %.

The “polypropylene component” may be, or comprise, a polymer having primarily isotacetic or syndiotacetic, or combinations of such polypropylene crystallinity. As such it will form an essentially crystalline phase. This polypropylene phase is typically the continuous phase in the hetero phase polymer composition of preferred embodiments.

The polypropylene component possesses a melting temperature (Tm), as determined by ASTM D-3417, of from 100° C. to 170° C. in one embodiment, from 110° C. to 170° C. in another embodiment, from 115° C. to 170° C. in another embodiment and, greater than 130° C. up to 160° C. in still another embodiment.

The polypropylene component possesses a heat of fusion (A Hf), as determined by DSC, ranging from 60 J/g to 95 J/g in one embodiment and from 70 J/g to 80 J/g in another embodiment and greater than 95 J/g in still another embodiment. Preferably, the crystallinity is higher for the polypropylene component than that of the propylene α-olefin copolymer component that may be added to this component as described below.

The polypropylene component may have a number average molecular weight (Mn) in the range of from 10,000 to 5,000,000 and a melt flow rate (MFR) (determined by the ASTM D1238 technique, condition L) in the range of from 0.5 to 200 or greater than 1 and/or less than 30 dg/min.

The polypropylene component may be a copolymer containing ce-olefin derived units generally ranging from 2 wt % to 70 wt % in one embodiment and from 2 wt % to 50 wt % in another embodiment and from 20 wt % to 40 wt % in still another embodiment, based on the total weight of the polypropylene component. Exemplary α-olefins are comprised of 4 to 12 carbon atoms and ethylene. For example, the α-olefin or α-olefins may be one or more of ethylene, butene-1,4-methyl-1-pentene, hexene-1, and octene-1.

In one embodiment, the polypropylene component has a melting point above 120° C. and is a random copolymer of propylene-derived units and up to 10 mol % ethylene and/or butene-1.

The polypropylene component described herein may be prepared using coordination polymerization as is well known in the art. This includes the use of traditional Ziegler-Natta catalyst systems as well as single-site organometallic catalyst systems, such as metallocene catalyst systems.

The polypropylene component may be provided by, or comprise, an impact copolymer (“ICP”). ICP's are themselves two phase systems, a largely crystalline polypropylene phase and a largely amorphous rubber phase, however in the present hetero phase blends, each of the two individual phases of the ICP may generally blend with the respective phase of the blend, i.e. crystalline and/or amorphous.

The ICP's have melt flow rates (MFR) of the polypropylene homopolymer portion of the ICP (determined by the ASTM D1238 technique, condition L) in the range of from 1 to 200, or at least 1 and/or less than 30 dg/min. Exemplary α-olefins for the rubber portion of the ICP, may be selected from one or more of ethylene; and C₄ to C₂₀ α-olefins such as butene-1; pentene-1,2-methylpentene-1,3-methylbutene-1; hexene-1,3-methylpentene-1,4-methylpentene-1,3,3-dimethylbutene-1; heptene-1; hexene-1; methylhexene-1; dimethylpentene-1 trimethylbutene-1; ethylpentene-1; octene-1; methylpentene-1; dimethylhexene-1; trimethylpentene-1; ethylhexene-1; methylethylpentene-1; diethylbutene-1; propylpentane-1; decene-1; methylnonene-1; nonene-1; dimethyloctene-1; trimethylheptene-1; ethyloctene-1; methylethylbutene-1; diethylhexene-1; dodecene-1 and hexadodecene-1. Of course, it is understood that the rubber component in materials of this type may contribute to, or principally comprise, the uncured ethylene copolymer component of the compositions described herein.

Suitably, if ethylene is the α-olefin in the rubber phase of the ICP, it may be present in the range of from 25 wt % to 70 wt % in one embodiment and from 30 wt % to 65 wt % in another embodiment, based on the weight of the rubber phase. The rubber phase may be present in the ICP in the range of from 4 wt % to 80 wt % in one embodiment, or from 6 wt % to 70 wt % in another embodiment, and less than 18 wt % in still another embodiment, all based on the total weight of the ICP. Exemplary ICP's having rubber contents less than 25 wt % are available from ExxonMobil Chemical Co. under the designation Escorene® and exemplary ICP's having rubber contents greater than 25 wt % are available under the designations Adflex, Hifax, and Profax from Basell North America Inc.

The MFR of the ICP may be in the range of from 0.5 dg/min to 60 dg/min in one embodiment, and from 1 dg/min to 40 dg/min in another embodiment and less than 30 dg/min in still another embodiment. The ICP may be of the type referred to as reactor blends.

The ICP may also be a physical blend of polypropylene and one or more elastomeric polymers of the ethylene α-olefin type, generally ethylene propylene elastomeric polymers. The ICP useful in certain embodiments may be prepared by conventional polymerization techniques such as a two-step gas phase process using Ziegler-Natta catalysis. In one embodiment, the ICP's are produced in reactors operated in series, and the second polymerization, may be carried out in the gas phase. The first polymerization may be a liquid slurry or solution polymerization process. Metallocene catalyst systems may be used to produce the ICP compositions described herein. Suitable metallocenes are those prochiral catalysts in the generic class of bridged, substituted bis(cyclopentadienyl) metallocenes, specifically bridged, substituted bis(indenyl) metallocenes known to produce high molecular weight, high melting, highly isotacetic propylene polymers. A description of semi-crystalline polypropylene polymers and reactor copolymers can be found in “Polypropylene Handbook” (E. P. Moore Editor, Carl Hanser Verlag, 1996).

In one embodiment, the at least one propylene component concentration in the formulations described herein ranges from 0.3 wt % to 83.5 wt %. In another embodiment, the at least one polypropylene component concentration ranges from 14 wt % to 65.5 wt % of the formulations.

The “cured, or cross-linked, rubber component” described herein may be derived from a thermoplastic vulcanizate (“TPV”) material. The TPV according to this disclosure is a thermoplastic elastomer. Thermoplastic elastomers have many of the properties of thermoset elastomers, yet they are processable as thermoplastics. TPV's are typically characterized by rubber particles, or a discontinuous rubber phase, dispersed within a thermoplastic resin. The rubber particles or phase consist of cross-linked rubber and therefore promote elasticity. TPV's are conventionally produced by dynamic vulcanization, which is curing, or vulcanizing, rubber within a blend with at least one thermoplastic resin while undergoing mixing or masticating at an elevated temperature, typically above the melt temperature of the thermoplastic resin (melt processing). Typically, the thermoplastic resin is non-vulcanizing, or not subject to significant cross-linking, under the melt processing conditions.

The TPV's described herein contain rubber that ranges from slightly cross-linked, e.g., less than 10% gel content, to fully cross-linked, i.e., greater than 95% gel content. Furthermore, the rubber may be cross-linked in any manner, e.g., with sulfur, phenolic, azide, and silicon-based curing agents, or through the action of a peroxide or radiation. The cross-linking is typically limited to the rubber phase but in certain circumstances can include some minor portion of the thermoplastic resin phase where such contains cross-linkable compounds, e.g., less than 5 wt % base upon total vulcanized rubber.

Any rubber or mixture thereof that is capable of being crosslinked or cured may be used as the rubber component of the TPV's. Reference to a rubber may include mixtures of more than one rubber. Some non-limiting examples of these rubbers include elastomeric ethylene α-olefin polymers wherein the α-olefins are C₄ to C₂₀, butyl rubber, natural rubber, styrene-butadiene copolymer rubber, butadiene rubber, acrylonitrile rubber, halogenated rubber such as brominated and chlorinated isobutylene-isoprene copolymer rubber, butadiene-styrene-vinyl pyridine rubber, urethane rubber, polyisoprene rubber, epichlolorohydrine terpolymer rubber, and polychloroprene. In one embodiment, the rubber is an elastomeric butyl rubber.

The term elastomeric polymer includes rubbery copolymers polymerized from ethylene, at least one α-olefin monomer, and optionally at least one diene monomer. The α-olefins may include, but are not limited to, propylene, 1-butene, 1-hexene, 4-methyl-1 pentene, 1-octene, 1-decene, or combinations thereof. In one embodiment, the α-olefin is selected from propylene, 1-hexene, 1-octene or combinations thereof. The diene monomers may include, but are not limited to, 5-ethylidene-2-norbornene; 1,4-hexadiene; 5-methylene-2-norbornene; 1,6-octadiene; 5-methyl-1,4-hexadiene; 3,7-dimethyl-1,6-octadiene; 1,3-cyclopentadiene; 1,4-cyclohexadiene; dicyclopentadiene; 5-vinyl-2-norbornene and the like, or a combination thereof. The preferred diene monomers are 5-ethylidene-2-norbornene and 5-vinyl-2-norbornene. The preferred elastomeric polymers include terpolymers of ethylene, propylene, and 5-ethylidene-2-norbornene or 5-vinyl-2-norbornene. Typically, such olefinic rubber components have an olefin crystallinity of less than 7% as measured by differential scanning calorimetry. Ethylene-based elastomeric copolymers are commercially available under the designations VISTALON (ExxonMobil Chemical; Houston, Tex.), KELTAN (DSM Copolymers; Baton Rouge, La.), NORDEL IP (DuPont Dow Elastomers; Wilmington, Del.), BUNA EP (Bayer; Germany) and ELASTOFLO (Dow Chemical, Midland, Mich.).

The term “butyl rubber” refers to rubbery amorphous copolymers of isobutylene and isoprene or an amorphous terpolymer of isobutylene, isoprene, and a divinyl aromatic monomer. These copolymers and terpolymers preferably contain from 0.5 to 10 percent by weight, or more preferably from 1 to 4 percent by weight, isoprene. The term butyl rubber also includes copolymers and terpolymers that are halogenated with from 0.1 to 10 weight percent, or preferably from 0.5 to 3.0 weight percent, chlorine or bromine. This chlorinated copolymer is commonly called chlorinated butyl rubber. Butyl rubber is satisfactory for use in the thermoplastic compositions described herein. In one embodiment, halogen-free butyl rubber containing from 0.6 to 3.0 percent unsaturation may be used. In another embodiment, butyl rubber having a polydispersity of 2.5 may be used. Butyl rubbers are commercially prepared by polymerization at low temperature in the presence of a Friedel-Crafts catalyst. Butyl rubber is commercially available from a number of sources as disclosed in the Rubber World Blue Book (Lippincott & Peto Publication, 2001). For example, butyl rubber is available under the designation POLYSAR BUTYL (Bayer; Germany) or the designation EXXON BUTYL (ExxonMobil Chemical).

The thermoplastic resin suitable in the TPV is a solid, generally high molecular weight plastic material. In one embodiment, the resin is a crystalline or a semi-crystalline polymer resin. In another embodiment, the resin has a crystallinity of at least 25 percent as measured by differential scanning calorimetry. Polymers with a high glass transition temperature are also acceptable as the thermoplastic resin. The melt temperature of these resins are preferably lower than the decomposition temperature of the rubber. As used herein, reference to a thermoplastic resin will include a thermoplastic resin or a mixture of two or more thermoplastic resins.

In one embodiment, the thermoplastic resins have a weight average molecular weight from 200,000 to 600,000, and a number average molecular weight from 80,000 to 200,000. In another embodiment, these resins have a weight average molecular weight from 300,000 to 500,000, and a number average molecular weight from 90,000 to 150,000.

The thermoplastic resins generally have a melt temperature (Tₘ) that is from 110° C. to 175° C. In one embodiment, the melt temperatures range from 140° C. to 170° C. In still another embodiment, the melt temperature ranges from 160° C. to 170° C. The glass transition temperature (T_{g}) of these resins generally ranges from minus 5° C. to 10° C. In another embodiment, the glass transition temperatures range from minus 3° C. to 5° C. In still another embodiment, the glass transition temperatures range from 0° C. to 2° C. The crystallization temperature (T_{c}) of these resins is generally from 95° C. to 130° C. In another embodiment, the crystallization temperatures range from 100° to 120° C. In still another embodiment, the crystallization temperatures range from 105° C. to 1150 C as measured by DSC and cooled at 10° C./min.

The thermoplastic resins generally have a melt flow rate that is less than 10 dg/min. In one embodiment, the melt flow rate is less than 2 dg/min. In another embodiment, the melt flow is less than 0.8 dg/min. Melt flow rate is a measure of how easily a polymer flows under standard pressure, and is measured by using ASTM D-1238 at 230° C. and 2.16 kg load.

Exemplary thermoplastic resins include crystalline polyolefins, polyimides, polyesters (nylons), poly(phenylene ether), polycarbonates, styrene-acrylonitrile copolymers, polyethylene terephthalate, polybutylene terephthalate, polystyrene, polystyrene derivatives, polyphenylene oxide, polyoxymethylene, and fluorine-containing thermoplastics. The crystalline polyolefins are typically those formed by the coordination polymerization of one or more of ethylene and x-olefins such as propylene, 1-butene, 1-hexene, 1-octene, 2-methyl-1-propene, 3-methyl-1-pentene, 4-methyl-1-pentene, 5-methyl-1-hexene, and mixtures thereof. Crystallinity containing copolymers of ethylene and propylene or ethylene or propylene with one or more other α-olefins such as 1-butene, 1-hexene, 1-octene, 2-methyl-1-propene, 3-methyl-1-pentene, 4-methyl-1-pentene, 5-methyl-1-hexene or mixtures thereof are preferable. These homopolymers and copolymers of two or more polymerizable monomers may be synthesized by using any polymerization technique known in the art such as, but not limited to, the “Phillips catalyzed reactions,” conventional Ziegler-Natta type coordination polymerizations, and organometallic coordination catalysis including, but not limited to, metallocene-alumoxane and metallocene-ionic activator catalysis.

In one embodiment the thermoplastic resin is highly crystalline isotacetic or syndiotacetic polypropylene. This polypropylene generally has a density of from 0.85 to 0.91 g/cm³, with the largely isotacetic polypropylene having a density of from 0.90 to 0.91 g/cm³. Also, high and ultra-high molecular weight polypropylene that has a fractional melt flow rate is highly preferred. These polypropylene resins are characterized by a melt flow rate that is less than or equal to 10 dg/min and more preferably less that or equal to 1.0 dg/min per ASTM D-1238.

The TPV's may incorporate certain processing aids. For example, rubber process oils may be used. Rubber process oils have particular ASTM designations depending on whether they fall into the class of paraffinic, naphthenic or aromatic process oils. They are derived from petroleum fractions. The type of process oil utilized will be that customarily used in conjunction with the rubber component. Those skilled in the area of thermoplastic compositions will recognize which type of oil is most beneficial for use with a particular rubber. The quantity of rubber process oil utilized is based on the total rubber content, both cured and uncured, and can be defined as the ratio by weight, of process oil to the total rubber in the formulation. The ratio of the processing oil may generally be up to 250 phr. The concentration of the process used is dependent on the specific composition the processing conditions used as recognized by those skilled in processing thermoplastic compositions. Generally speaking, the higher the concentration of process oil used, the lower the physical strength of the composition. Oils other than petroleum based oils, such as oils derived from coal tar and pine tar, can also be utilized. In addition to the petroleum derived rubber process oils, organic esters and other synthetic plasticizers can be used.

The ratio of the process oil defined above includes the extending oil that may be contained in the cross-linkable rubber prior to vulcanization plus additional oil added during the manufacture of the thermoplastic elastomer.

Antioxidants may also be incorporated in to the TPV's. The particular antioxidant utilized, if any, will depend on the rubbers utilized and more than one type may be required. Their proper selection is well within the ordinary skill of the rubber and thermoplastic processing chemist. Antioxidants will generally fall into the class of chemical protectors or physical protectors.

Physical protectors may be included in the TPV's as well. Physical protectors may be used where there is to be little movement in the article to be manufactured from the composition. The physical antioxidants include mixed petroleum waxes and microcrystalline waxes. These generally waxy materials impart a “bloom” to the surface of the rubber part and form a protective coating to shield the part from oxygen, ozone, etc.

The TPV's may also incorporate chemical protectors. The chemical protectors generally fall into three chemical groups; secondary amines, phenolics and phosphates. Illustrative, non-limiting examples of types of antioxidants useful in the practice of this invention are hindered phenols, amino phenols, hydroquinones, alkyldiamines, amine condensation products, etc. Further non-limiting examples of these and other types of antioxidants are styrenated phenol; 2,2′-methylene-bis(4-methyl-6-t-butylphenol); 2,6′-di-t-butyl-o-di-methlamino-p-cresol; hydroquinone monobenzyl ether, octylated diphenyl amine; phenyl-beta-naphthylamine; N,N′-diphenylethylene diamine; aldol-alpha-naphthylamine; N,N′-diphenyl-p-phenylene diamine, etc.

Exemplary TPV materials suitable for inclusion in the weldable thermoplastic compositions described herein include, but not limited to, those available from Advanced Elastomer Systems, L.P. (Akron, Ohio) under the designations SANTOPRENE®, VYRAM®, GEOLAST®, DYTRON®, and TREFSIN® or those available from DSM under the designation SARLINK®, and those available from Teknor Apex under the designation Uniprene®.

In the finally formulated sheet compositions of the invention, the at least one cured rubber component concentration ranges from 0.3 wt % to 24.5 wt %. In another embodiment, the at least one cured rubber component concentration ranges from 1.0 wt % to 15 wt % of the formulations. In still another embodiment, the at least one cured rubber component concentration ranges from 2 wt % to 12 wt % of the formulations.

In a preferred manner of preparing the thermoplastic sheets of the invention, the uncured elastomeric component, the polypropylene-based thermoplastic component, and the TPV component are combined, melt blended at a temperature at or above the melting temperature of the polypropylene-based thermoplastic component, and then extruded to form sheet or membrane compositions. In this preparation process, the amount of TPV to be combined ranges 1 wt % to 42 wt % of the total weight of the total composition. In another embodiment, the amount TPV component ranges from 3 wt % to 35 wt %. In still another embodiment, the at least one TPV component concentration ranges from 5 wt % to 25 wt % of the formulations. Additional additive components, addressed below, may be introduced through the TPV, may be combined with the components by adding prior to or during melt blending, or may be added afterwards, with additional blending as needed, before extrusion.

The compositions described herein may also contain an optional fourth component that is hereinafter referred to as a “propylene α-olefin copolymer”. This component comprises a propylene α-olefin copolymer having a propylene-derived crystallinity, isotacetic, syndiotacetic, or combination thereof. Such crystallinity distinguishes the propylene α-olefin copolymer from the olefin copolymers described above for the elastomeric components that are either cured or uncured. In one embodiment, ethylene is copolymerized with the propylene. In other embodiments, ethylene may be replaced, in part or wholly, with higher α-olefins ranging from C₄-C₂₀, such as, for example, 1-butene, 4-methyl-1-pentene, 1-hexene or 1-octene and 1-decene, and mixtures thereof. The propylene content may range from 50 wt % to 92 wt % in one embodiment and from 70 wt % to 90 wt % in another embodiment and from 75 wt % to 90 wt % in another embodiment.

The propylene α-olefin copolymer component will comprise crystallinity that is isotacetic, syndiotacetic or combinations thereof. This tacticity may be selected to ensure compatibility, especially relative to the polypropylene thermoplastic component. In some embodiments, the tacticity of the polypropylene component and the specialty thermoplastic olefin component may be substantially the same, by substantially it is meant that these two components have at least 80% of the same tacticity. In another embodiment, the components have at least 90% of the same tacticity. In still another embodiment, the components have at least 100% of the same tacticity. Even if the components are of mixed tacticity being partially isotacetic and partially syndiotacetic, the percentages in each are at least 80% the same as the other component in one embodiment.

In a preferred embodiment, both the polypropylene component and the specialty thermoplastic olefin component possesses isotacetic sequences. The type and level of crystallinity may be determined by NMR. For the specialty thermoplastic olefin component the presence of isotacetic sequences can be determined by NMR measurements showing two or more propylene derived units arranged isotactically. In the specialty thermoplastic olefin component, the isotacetic sequences may be interrupted by propylene units that are not isotactically arranged or by other monomers that otherwise disturb the crystallinity derived from the isotacetic sequences. The crystallinity of the specialty thermoplastic olefin component may range from 2% to 65% as measured by differential scanning calorimetry in one embodiment and from 5% to 40% in another embodiment.

Thus, the specialty thermoplastic olefin component has a heat of fusion of less than 45 J/g in one embodiment. The crystallinity interruption may be predominantly controlled by the incorporation of monomer units other than propylene, such as ethylene. The comonomer content of the specialty thermoplastic olefin component may be a copolymer may range from 5 wt % to 25 wt % in one embodiment and from 10 wt % to 25 wt % in another embodiment and from 15 wt % to 25 wt % in still another embodiment.

The specialty thermoplastic olefin component may include some or all of the following characteristics, where ranges from any recited upper limit to any recited lower limit are contemplated: a melting point, generally a single melting point, ranging from 70° C. to 100° C. in one embodiment and from 80° C. to 105° C. in another embodiment and from 80° C. to 90° C. in still another embodiment; a heat of fusion ranging from 1.0 joule per gram (J/g) to 40 J/g in one embodiment and from 5 J/g to 35 J/g in another embodiment and from 7 J/g to 25 J/g in still another embodiment; a molecular weight distribution (MWD) M_{w}/Mₙ ranging from 1.5 to 40 in one embodiment and from 2 to 20 in another embodiment and from 2 to 10 in still another embodiment; a number average molecular weight of from 10,000 to 5,000,000 in one embodiment or from 40,000 to 300,000 in another embodiment or from 80,000 to 200,000 in still another embodiment, as determined by gel permeation chromatography (GPC); or a Mooney viscosity ML (1+4)@125° C. from 75 to 100 in one embodiment.

In certain embodiments, at least 75 wt %, or at least 80 wt %, or at least 85 wt %, or at least 90 wt %, or at least 95 wt %, or at least 97 wt %, or at least 99 wt % of the specialty thermoplastic olefin component may be soluble in a single temperature fraction, or in two adjacent temperature fractions, with the balance of the copolymer in immediately preceding or succeeding temperature fractions. These percentages are fractions, for instance in hexane, beginning at 23° C. and the subsequent fractions are in approximately 8° C. increments above 23° C. Meeting such a fractionation requirement means that a polymer has statistically insignificant intermolecular differences in propylene tacticity.

An exemplary propylene α-olefin copolymer useful in the weldable compositions described herein is designated propylene α-olefin copolymer-1 in this disclosure. Propylene α-olefin copolymer-1 is a propylene ethylene copolymer having an ethylene content of 18 wt % and a Mooney Viscosity ML (1+4) 125° C. of 18.

Fractionations may be conducted in boiling pentane, hexane, heptane and even di-ethyl ether. In such boiling solvent fractionations, polymers making up compatibilizing components of embodiments of our invention may be totally soluble in each of the solvents, offering no analytical information. For this reason, we have chosen to do the fractionation as referred to above and as detailed herein, to find a point within these traditional fractionations to more fully describe our polymer and the surprising and unexpected insignificant intermolecular differences of tacticity of the polymerized propylene.

In one embodiment, the specialty thermoplastic olefin component polymers are generally devoid of any substantial intermolecular heterogeneity in tacticity and comonomer composition. They are also substantially devoid of any substantial heterogeneity in intramolecular composition distribution. This is typical of metallocene catalyst produced polymers. Intramolecular heterogeneity is not intrinsic to metallocene polymers and can only be forced through composition sequencing during synthesis (e.g., series reactors).

The specialty thermoplastic olefin component has a crystalline portion and an amorphous portion, the amorphous portion being the result of irregularity introduced by a catalyst or by the amount and nature of a comonomer. This specialty thermoplastic olefin component is more fully discussed in published U.S. Pat. No. 6,288,171 as the random propylene copolymer.

In one embodiment, the at least one specialty thermoplastic olefin component concentration in the formulations described herein ranges from 1 wt % to 55 wt % of the formulation. In another embodiment, the at least one specialty thermoplastic olefin component concentration ranges from 3 wt % to 45 wt % of the formulation. In still another embodiment, the at least one specialty thermoplastic olefin component concentration ranges from 3 wt % to 30 wt % of the formulation.

The compositions described herein may also incorporate a variety of additives, or “conventional additives” known in the art. The additives may include reinforcing and non-reinforcing fillers, antioxidants, stabilizers, rubber processing oils, rubber/thermoplastic phase compatibilizing agents, lubricants (e.g., oleamide), antiblocking agents, antistatic agents, waxes, coupling agents for the fillers and/or pigment, foaming agents, pigments, flame retardants, antioxidants, and other processing aids known to the rubber compounding art. Exemplary flame retardants are inorganic clays containing water of hydration such as aluminum trihydroxides (“ATH”) or Magnesium Hydroxide”. The additives comprise up to 74 wt % of the total formulation in one embodiment. In another embodiment, the additives comprise up to 60 wt % of the formulation. In still another embodiment, the additives comprise up to 50 wt % of the formulations.

Many fillers and coloring agents may be incorporated in the heat-weldable thermoplastic compositions. Exemplary materials include inorganic fillers such as calcium carbonate, clays, silica, talc, titanium dioxide or carbon black. Any type of carbon black can be used, such as channel blacks, furnace blacks, thermal blacks, acetylene black, lamp black and the like.

It has been unexpectedly determined that the formulations described herein provide weldable thermoplastic compositions with beneficial properties. The heat-weldable thermoplastic compositions described herein have a good balance of flexibility, physical properties, and heat welding performance. In certain preferred embodiments, the compositions exhibit a reduced propensity to blocking in comparison to conventional thermoplastic material membranes.

As mentioned previously, the compositions described herein are multiple phase materials in which each phase is formed by the polypropylene component, the uncured polymeric component, or the cured rubber component. Typically, the polypropylene component or the uncured polymeric component is continuous, thereby forming a matrix in which the other two phases exist as isolated regions dispersed within the continuous phase. Mixing or blending pellets of the three components, along with any additives, in an apparatus such as an extruder at elevated temperatures and pressures is a typical process for producing the invention compositions. In a preferred embodiment, the dispersed phase will be comprised of dispersed particles having a particle size that ranges from 0.5 to 3 microns. Generally, the component present in the highest content forms the continuous phase, and the other components become dispersed throughout the molten thermoplastic continuous matrix.

However, in an alternative method of preparing the thermoplastic sheet compositions of the invention, the cured rubber component may be produced during the process of melt blending the components. In one exemplary embodiment of this type, a component selected to be the vulcanized rubber component (from any of the classes of rubbers described for the TPV compositions), but prior to cross-linking or curing, is combined with the polypropylene component and the uncured elastomeric component. The combined materials are then melt blended together typically at temperatures higher than the melting point of the polypropylene component in the presence of a cross-linking agent. Through this process, the curable rubber component is vulcanized using conventional vulcanizing agents that are ineffective to cross-link the uncured thermoplastic, the ethylene random copolymer or the ethylene random copolymer and the uncured ethylene-propylene rubber, while the curable rubber component is dispersed within the polypropylene component in the manner described above in connection with formation of the TPV. Suitable cross-linking agents include sulfur, phenol and silicon-based curing compounds.

The following examples are illustrative of specific embodiments of the weldable compositions described herein. All parts and percentages are by weight unless otherwise noted.

### EXAMPLES 1-9 AND 14-50

Table I, Table III and Table IV list formulations compounded in a single-screw extruded under equipment setup of A or B outlined below. Setup A used a 48 inches (121.9 cm) wide sheeting die where the 3.5 inches (8.9 cm) extruder was fitted with a Maddock mixing screw having a L/D ratio of 24:1. This screw had a compression ratio of 3.5:1. The extruder rpm was adjusted between 10 and 20. Setup B used a 12 inches (30.5 cm) sheeting die where the 1.5″ (38 mm) extruder was fitted with a Barrier Maddock screw having a L/D ratio of 24:1. The screw had a compression ratio of 2.3:1. The extruder rpm was 100. In both setups the temperature of the extruder at zones 1-4 ranged from 16° ° C. to 183° C. The die temperatures ranged from 160° C. to 188° C. The die pressures varied from 0.75×10⁷ Pascal to 1.93×10⁷ Pascal. The melt material temperature exiting the extruder ranged from 175° C.-190° C. Approximately 11.3 kilograms of the formulations were tumble blended and feed directly into the extruder hopper. The components were melt-blended and extruded into a single ply sheet with a thickness ranging from 20 mils (0.5 mm) to 40 mils (1 mm). Thickness control was accomplished by increasing the roll pressure and speed of the calendar rolls.

Comparative Examples 1 and 2 were formulated using EXACT 0201 plastomer (ethylene-octene) and a polypropylene homopolymer, available from ExxonMobil Chemical under the designations indicated in Table I, and impact copolymer matrix materials respectively as indicated, using setup A. The weld peel strength of these membranes after heat aging was relatively low and the samples exhibited easy separation. Example 6 demonstrates that addition of a TPV (VYRAM 9201-65) improved the heat aged weld peel strength.

Comparative Examples 3 and 4 are formulations containing a lower density ethylene-octene plastomer (EXACT 8201). These formulations demonstrated good weld strength characteristics. Addition of a TPV as demonstrated in Example 7 preserved the welding performance and enhanced flexibility characteristics as evidenced by the reduction in 15% and 100% modulus values.

TABLE IA

| Melt Flow Rate (g/10 min) | | | | | | | | |
|---|---|---|---|---|---|---|---|---|
| 3.2 | 3.0 | 2.8 | 2.9 | 3.7 | 3.5 | 3.3 | 4.0 | 4.7 |
| EXAMPLE | | | | | | | | |
| 1 | 2 | 3 | 4 | 5 | | | | |
| (Comp.) | (Comp.) | (Comp.) | (Comp.) | (Comp.) | 6 | 7 | 8 | 9 |

Formulation (wt %)

| | | | | | | | | | |
|---|---|---|---|---|---|---|---|---|---|
| EXACT 0201 (1.1 MI, 0.902 | 48.3 | 48.3 | | | | 38.3 | | | |
| d, C8) | | | | | | | | | |
| EXACT 8201 (1.1 MI, 0.882 | | | 48.3 | 48.3 | | | 38.3 | | |
| d, C8) | | | | | | | | | |
| Vyram 9201-65 | | | | | | 10.0 | 10.0 | 10.0 | 10.0 |
| propylene α-olefin copolymer | | | | | 32.1 | | | 22.1 | 22.1 |
| (18 ML, 18% C₂) | | | | | | | | | |
| polypropylene 4712 E1 (3 | 16.0 | | 16.0 | | 32.1 | | | 32.1 | |
| MFR, Homopolymer) | | | | | | | | | |
| polypropylene 7032 E2 (3 | | 16.0 | | 16.0 | | 16.0 | 16.0 | | 32.1 |
| MFR, ICP) | | | | | | | | | |
| Adflex KS 359 P (13 MI) | 10.7 | 10.7 | 10.7 | 10.7 | 10.7 | 10.7 | 10.7 | 10.7 | 10.7 |
| Magnesium Hydroxide | 25.0 | 25.0 | 25.0 | 25.0 | 25.0 | 25.0 | 25.0 | 25.0 | 25.0 |
| UV Stabilizer | 0.50 | 0.50 | 0.50 | 0.50 | 0.50 | 0.50 | 0.50 | 0.50 | 0.50 |
| TiO₂ Master Batch (70% Active) | 7.0 | 7.0 | 7.0 | 7.0 | 7.0 | 7.0 | 7.0 | 7.0 | 7.0 |

TABLE IB
Properties

| EXAMPLE | | | | | | | | |
|---|---|---|---|---|---|---|---|---|
| 1 | 2 | 3 | 4 | 5 | | | | |
| (Comp.) | (Comp.) | (Comp.) | (Comp.) | (Comp.) | 6 | 7 | 8 | 9 |

Physical Properties/Tested @ 508 mm/min/20 mil sheet (Mean Values)

| | | | | | | | | | |
|---|---|---|---|---|---|---|---|---|---|
| 15% Modulus (ASTM D 412) | 9.501 | 9.101 | 8.198 | 7.598 | 10.301 | 7.798 | 5.902 | 8.501 | 8.398 |
| (MPa) | | | | | | | | | |
| 100% Modulus (ASTM D 412) | 9.901 | 10.397 | 8.398 | 7.798 | 10.501 | 9.101 | 8.701 | 14.596 | 13.796 |
| (MPa) | | | | | | | | | |
| Tensile Stress @ yield | 10.590 | 10.783 | 8.749 | 8.046 | 11.356 | 9.363 | 7.164 | 14.769 | 13.996 |
| (ASTM D 412) (MPa) | | | | | | | | | |
| Elongation @ yield | 25 | 40 | 45 | 47 | 35 | 49 | 80 | 109 | 97 |
| (ASTM D 412) (%) | | | | | | | | | |
| Tensile @ Break | 29.909 | 28.565 | 26.497 | 20.022 | 19.478 | 17.637 | 19.698 | 22.567 | 21.629 |
| (ASTM D 412) (MPa) | | | | | | | | | |
| Elongation @ Break | 1498 | 1514 | 1672 | 1414 | 1269 | 1142 | 1307 | 801 | 896 |
| (ASTM D 412) (%) | | | | | | | | | |
| Tear Die C (Peak Value) | 106.8 | 107.4 | 93.3 | 82.3 | 91.2 | 107.7 | 97.0 | 82.8 | 85.8 |
| (ASTM D 624) (kN/m) | | | | | | | | | |

Heat Weld Peel Strength

| | | | | | | | | | |
|---|---|---|---|---|---|---|---|---|---|
| Test Conditions (Temp - | 620/5.0 | — | 482/5.0 | 482/5.0 | 510/5.0 | 620/5.0 | 528/5.0 | 620/5.0 | 620/5.0 |
| ° C./Speed - m/min) | | | | | | | | | |
| Non-Aged (kN/m) | 3.3 | — | 4.0 | — | 5.3 | — | — | — | — |
| Aged for 48 hrs @ | 1.8 | — | | 4.6 | | 3.0 | 3.7 | 4.0 | 4.0 |
| 80° C. (kN/m) | | | | | | | | | |
| Heat Weld Peel Strength | — | — | | | | — | — | — | — |
| Test Conditions (Temp - | 460/4.0 | — | 620/5.0 | — | 620/5.0 | — | — | 538/5.0 | — |
| ° C./Speed - m/min) | | | | | | | | | |
| Aged for 48 hrs @ | 1.9 | — | 4.3 | — | 5.5 | — | — | 3.9 | — |
| 80° C. (kN/m) | | | | | | | | | |
| Roll Sticking | none | — | None | slight | bad | slight | slight | slight | bad |
| Puncture Resistance | 268 | — | 252 | 228 | 248 | 245 | 212 | 260 | 237 |

Examples 8 and 9 are formulations containing a TPV, ethylene-propylene polymer with isotacetic propylene crystallinity, polypropylene homopolymer, and impact copolymer respectively. By comparing Example 8 with Example 5, it is seen that the addition of the TPV eliminates roll sticking and maintained adequate weld peel strength.

Table II provides additional examples of thermoplastic polyolefin roofing membranes incorporating TPV's and ethylene-octene plastomers. These compounds were prepared in a Brabender mixer at 180° C. and mixed at 100 RPM using a batch size of 60 grams. The compounds discharged from the mixer were compressed molded at 204° C. into test specimens of 2 mm thickness.

TABLE II

| EXAMPLE | | | |
|---|---|---|---|
| 10 | | | |
| (Comp.) | 11 | 12 | 13 |

Formulation (wt %)

| | | | | |
|---|---|---|---|---|
| Endura ZH6775 | 33.00 | 33.00 | 33.00 | 33.00 |
| Exact 0201 | 66.00 | 56.00 | 46.00 | 36.00 |
| ESC91234 | 3.00 | 3.00 | 3.00 | 3.00 |
| White Color MB | 7.00 | 7.00 | 7.00 | 7.00 |
| Vyram 9201-65 | | 10.00 | 20.00 | 30.00 |
| Total | 109.00 | 109.00 | 109.00 | 109.00 |

Physical Properties, Non-Aged

| | | | | |
|---|---|---|---|---|
| Hardness, Shore D | 42 | 40 | 36 | 33 |
| 50% Modulus, Mpa | 7.102 | 6.233 | 5.288 | 4.999 |
| (ASTM D 412) | | | | |
| 100% Modulus, Mpa | 6.943 | 5.923 | 4.909 | 4.675 |
| (ASTM D 412) | | | | |
| Tensile Strength, | 21.436 | 17.499 | 12.721 | 9.287 |
| Mpa (ASTM D 412) | | | | |
| Ult. Elongation, % | 746 | 737 | 728 | 693 |
| Toughness, Mpa | 70.878 | 59.150 | 46.360 | 38.859 |

Heat Aged 2 week @110° C.

| | | | | |
|---|---|---|---|---|
| Hardness, Shore | softened | 38 | 39 | 37 |
| 50% Modulus, Mpa | unable | 4.364 | 4.578 | 5.550 |
| | to test | | | |
| 100% Modulus, Mpa | unable | 4.385 | 4.268 | 5.343 |
| (ASTM D 412) | to test | | | |
| Tensile Strength, | unable | 7.543 | 8.239 | 9.191 |
| Mpa (ASTM D 412) | to test | | | |
| Ult. Elongation, % | unable | 603 | 693 | 731 |
| | to test | | | |
| Toughness, Mpa | unable | 31.792 | 34.377 | 44.278 |
| | to test | | | |
| Weight Change (%) | unable | −6.42 | −0.97 | −1.46 |
| | to test | | | |

As seen by comparing Examples 12 and 13 with Comparative Example 10, the addition of a TPV at levels of 10 wt %-30 wt % improved heat aging performance. The formulation of Example 10 softened when exposed to a high temperature environment because of the lower melting temperature of the ethylene-octene plastomer, while Examples 11, 12 and 13 maintained their structural integrity.

Table III (below) provides membrane formulations incorporating a TPV, an ethylene-propylene polymer with isotacetic propylene crystallinity, and at least one ethylene-octene plastomer. These formulations were prepared in a single-screw extruder per setup A as described above.

Examples 14-16 are comparative formulations. By comparing Example 17 to these Examples, it is seen that the addition of 5 wt % of a TPV enhances weld peel strength. Example 18, incorporating a higher concentration of a TPV, also showed good heat weld peel strength. The formulations of Examples 19 and 20 incorporated both a TPV and an ethylene-propylene polymer with isotacetic propylene crystallinity. Both formulations exhibited high peel strength in comparison to Examples 14-16. Table IV discloses weldable composition formulations incorporating various concentrations of a TPV component. The compositions were used to form roofing membranes per setup B as described above.

The TPV component used in the compositions of Table IV (below) Examples is Vyram 9201-65 available from Advanced Elastomer Systems, L.P. All formulations in Examples 21-50 are comprised of a flame retardant component designated as Endura ZH6775 available form Polymer Products Company (Mooresville, N.C.). This component is a blend comprising 70 wt % powdered magnesium hydroxide, which is selected for its flame retardant properties, and 30 wt % of a high rubber content polypropylene impact copolymer. In all Table IV Examples, Endura ZH6775 is present at 45 wt %. In addition, to the TPV and polypropylene components, the compositions are comprised of either an ethylene α-olefin polymer component which is either Exact 0201 (ethylene-octene plastomer) available from ExxonMobil Chemical Company or Hifax Calif. 10A polypropylene impact copolymer available from Basell Polyolefins. All Table IV compositions also contain 7 wt % Lancer ESC12427 which is a titanium dioxide containing master batch available from Lancer Dispersions, Inc (Akron, Ohio) and used as a whitening agent, and 3 wt % Lancer ESC91234 which is a UV stabilizer containing master batch available from Lancer Dispersions, Inc (Akron, Ohio).

TABLE IIIA
Formulations

| EXAMPLE | | | | | | |
|---|---|---|---|---|---|---|
| 14 | 15 | 16 | | | | |
| (Comparative) | (Comparative) | (Comparative) | 17 | 18 | 19 | 20 |

Formulation (wt %)

| | | | | | | | |
|---|---|---|---|---|---|---|---|
| EXACT 0201 (1.1 MI, 0.902 d, C8) | | 22.0 | 32.0 | 27.0 | 30.0 | 10.0 | 21.0 |
| EXACT 8201 (1.1 MI, 0.882 d, C8) | 44.0 | 22.0 | 12.0 | 12.0 | | | |
| Vyram 9201-65 | | | | 5.0 | 10.0 | 10.0 | 3.0 |
| propylene α-olefin copolymer (18 | | | | | | 10.0 | 6.0 |
| ML, 18 C2) | | | | | | | |
| PP 4712 E1 (3 MFR, Homopolymer) | 16.0 | 16.0 | 16.0 | 16.0 | 20.0 | 30.0 | 30.0 |
| PP 7032 E2 (3 MFR, ICP) | | | | | | | |
| Adflex KS 359 P (13 MI) | 11.1 | 11.1 | 11.1 | 11.1 | 11.1 | 11.1 | 11.1 |
| UV Tec (Magnesium Hydroxide) | 21.0 | 21.0 | 21.0 | 21.0 | 21.0 | 21.0 | 21.0 |
| UV Stabilizer (Tinuvin 328 & | 3.0 | 3.0 | 3.0 | 3.0 | 3.0 | 3.0 | 3.0 |
| Chimasorb 119) | | | | | | | |
| Black Master Batch | | | | | | | |
| TiO₂ Master Batch (70% Active) | 4.9 | 4.9 | 4.9 | 4.9 | 4.9 | 4.9 | 4.9 |
| Total Formulation | 100.0 | 100.0 | 100.0 | 100.0 | 100.0 | 100.0 | 100.0 |
| Melt Flow Rate (g/10 min) | 3.0 | 3.0 | 3.0 | 2.8 | 2.9 | 3.2 | 3.2 |

* No overlap weld

TABLE IIIB
Properties

| EXAMPLE | | | | | | |
|---|---|---|---|---|---|---|
| 14 | 15 | 16 | | | | |
| (Comparative) | (Comparative) | (Comparative) | 17 | 18 | 19 | 20 |

Physical Properties/Tested @ 20 in/min/20 mil membrane (Mean Values)

| | | | | | | | |
|---|---|---|---|---|---|---|---|
| 100% Modulus (ASTM D 412) (MPa) | 7.901 | 9.101 | 9.198 | 8.701 | 10.197 | 11.900 | 12.197 |
| Tensile Stress @ yield (ASTM D 412) | — | 9.260 | 9.480 | 9.039 | 10.756 | 12.590 | 13.941 |
| (MPa) | | | | | | | |
| Elongation @ yield (ASTM D 412) (%) | — | 40 | 40 | 48 | 50 | 42 | 15 |
| Tensile @ Break (ASTM D 412) (MPa) | 21.663 | 19.491 | 21.057 | 20.429 | 18.126 | 14.913 | 14.872 |
| Elongation @ Break (ASTM D 412) (%) | 1345 | 1141 | 1207 | 1381 | 1183 | 843 | 916 |
| Tear Die C (Peak Value) (ASTM D 624) | 68.1 | 76.4 | 74.3 | 69.5 | 66.4 | 73.7 | 80.2 |
| (kN/m) | | | | | | | |
| Heat Weld Peel Strength | — | — | — | — | — | — | — |
| Test Conditions (Temp ° C./Speed | — | — | — | — | — | — | — |
| m/min) (620/5.0) | | | | | | | |
| Aged for 48 hrs @ 80° C. (kN/m) | 3.7 | 3.5 | 3.9 | 5.8 | 10.9* | 7.4 | 7.0 |
| Aged on roof for 2 weeks (kN/m) | — | — | 1.9 | 4.4 | 3.5 | 1.8 | 6.1 |
| Roll Sticking | none | none | none | none | none | none | none |

Examples 21, 28, 35, and 42 are comparative formulations providing performance data for formulations without a TPV component. Examples 27, 34, 41, and 48 are comparative formulations providing performance data for formulations without an ethylene α-olefin polymer component.

By reviewing the Table IV Examples, the beneficial welding performance effects, provided by the inclusion of TPV component, in weathered compositions are observed. Specifically, it is demonstrated that the deleterious effects of aging on the weld strength performance is minimized or eliminated by the inclusion of a TPV component in the compositions. This beneficial effect is revealed by comparing the weld strengths before aging and after weathered aging on a roof. The roof aged data was generated by forming roof membrane structures from the compositions and aging the membranes on a roof at zero incline at ambient conditions for approximately 1 month in Pensacola, Fla. (January-February, 2003) and then welding the composition to itself and measuring the resulting weld strength. The roof aging method can be accelerated as described in ASTM G-90-98 using the EMMAQUA® system through Atlas Weathering Services Group.

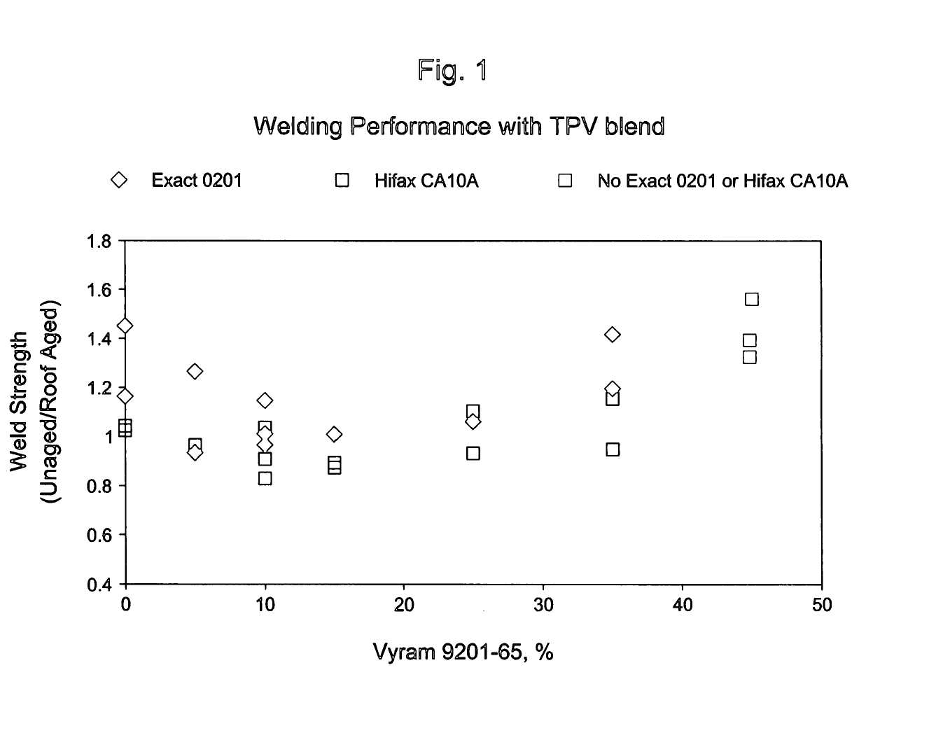

The graph in FIG. 1 plots the weld strength performance of the compositions described in the Table IV Examples. Specifically, FIG. 1 plots the quotient calculated by dividing the unaged weld strength (peel strength) by the roof aged weld strength for each Example. Therefore, a value of 1.0 means that the weld strength potential of the composition was unaffected by aging. A value greater than 1.0 means that the weld strength potential of the composition was reduced by aging. Finally, a value of less than 1.0 corresponds to the weld strength potential of the composition increasing upon roof aging. These values will be referred to hereinafter as “weld quotients”.

To compare the welding performance of the three component blends described herein, comparative Examples 21, 27, 28, 34, 35, 41, 42, and 48 containing only two of the components were prepared and tested. From Table IV (below), it can be seen that some formulations were produced and tested more than once to verify accuracy in testing results.

The FIG. 1 plot reveals that the EXACT® ethylene α-olefin polymer composition, without a TPV component, had an average weld quotient of approximately 1.29. The Hifax ethylene α-olefin polymer composition, without a TPV component, exhibited an average weld quotient of approximately 1.04. The TPV and polypropylene blend had an average weld quotient of approximately 1.42.

Continuing to examine the data points of FIG. 1, it is observed that inclusion of a TPV component in both the Exact ethylene α-olefin polymer and Hifax ethylene α-olefin polymer blends improved weld strength performance. Moreover, the weld strength performance of a polypropylene component and TPV component blend composition improved by inclusion of a third component as described herein. Specifically, the highest weld quotients of Exact-based three component blends that were lower than the lowest weld quotient of the Exact-based two component blends contained approximately 10 wt % TPV at the lower end and approximately 30 wt % TPV at the upper end. The highest weld quotients of the Hifax-based three component blends that were lower than the lowest weld quotients of the Hifax-based two component blends contained approximately 5 wt % TPV at the lower end and approximately 25 wt % TPV at the upper end. The weld quotient for all but one of the three component blends was lower then the polypropylene and TPV two-component blend.

Since the TPV two component blend produces poor welding performance, it was unexpected that inclusion of the TPV component to form a three component blend would result in compositions having superior heat-aged weld strength performance. The welding strength performance improvement is observed at TPV component concentrations ranging from 5 wt % to 30 wt % of the three component compositions described herein.

TABLE IV

| | 21 | 22 | 23 | 24 | 25 | 26 | 27 | 28 | 29 | 30 |
|---|---|---|---|---|---|---|---|---|---|---|
| Formulation (wt %) | | | | | | | | | | |
| Endura ZH6775 | 45 | 45 | 45 | 45 | 45 | 45 | 45 | 45 | 45 | 45 |
| Lancer ESC12427 | 7 | 7 | 7 | 7 | 7 | 7 | 7 | 7 | 7 | 7 |
| Lancer ESC91234 | 3 | 3 | 3 | 3 | 3 | 3 | 3 | 3 | 3 | 3 |
| Vyram 9201-65 | 0 | 5 | 10 | 15 | 25 | 35 | 45 | 0 | 5 | 10 |
| Exact 0201 | 45 | 40 | 35 | 30 | 20 | 10 | 0 | 45 | 40 | 35 |
| Hifax CA10A | | | | | | | | | | |
| Total | 100 | 100 | 100 | 100 | 100 | 100 | 100 | 100 | 100 | 100 |
| Physical | | | | | | | | | | |
| Properties, Unaged | | | | | | | | | | |
| 100% Modulus, Mpa | 6.784 | 6.040 | 5.626 | 4.950 | | 3.716 | 3.303 | 6.529 | 6.212 | 5.805 |
| (ASTM D 412) | | | | | | | | | | |
| Tens. Strength, Mpa | 19.016 | 9.666 | 5.957 | 5.095 | 4.082 | 3.689 | 3.544 | 11.652 | 10.646 | 6.840 |
| (ASTM D 412) | | | | | | | | | | |
| Ult. Elongation, % | 685 | 547 | 380 | 154 | 96 | 139 | 236 | 556 | 562 | 448 |
| Tear Strength, kN/m | 66.9 | 55.7 | 47.8 | 38.7 | 31.7 | 28.5 | 27.7 | 56.4 | 55.7 | 45.4 |
| Puncture | 194 | 173 | 158 | 143 | 115 | 102 | 94 | 193 | 182 | 167 |
| Weld Strength on | 3.3 | 2.7 | 2.3 | 2.0 | 1.8 | 2.3 | 2.5 | 3.5 | 2.5 | 2.5 |
| Unaged Sheet, kN/m | | | | | | | | | | |
| Properties. Aged | | | | | | | | | | |
| Weld Strength on | 2.3 | 2.1 | 2.0 | * | * | 1.6 | 1.6 | 3.0 | 2.7 | 2.4 |
| Roof Aged Sheet, | | | | | | | | | | |
| kN/m | | | | | | | | | | |

| | 31 | 32 | 33 | 34 | 35 | 36 | 37 | 38 | 39 |
|---|---|---|---|---|---|---|---|---|---|
| Formulation (wt %) | | | | | | | | | |
| Endura ZH6775 | 45 | 45 | 45 | 45 | 45 | 45 | 45 | 45 | 45 |
| Lancer ESC12427 | 7 | 7 | 7 | 7 | 7 | 7 | 7 | 7 | 7 |
| Lancer ESC91234 | 3 | 3 | 3 | 3 | 3 | 3 | 3 | 3 | 3 |
| Vyram 9201-65 | 15 | 25 | 35 | 45 | 0 | 5 | 10 | 15 | 25 |
| Exact 0201 | 30 | 20 | 10 | 0 | | | | | |
| Hifax CA10A | | | | | 45 | 40 | 35 | 30 | 20 |
| Total | 100 | 100 | 100 | 100 | 100 | 100 | 100 | 100 | 100 |
| Physical | | | | | | | | | |
| Properties, Unaged | | | | | | | | | |
| 100% Modulus, Mpa | 5.033 | | | | 6.074 | 5.578 | | | |
| (ASTM D 412) | | | | | | | | | |
| Tens. Strength, Mpa | 5.440 | 4.261 | 3.185 | 3.275 | 8.039 | 5.578 | 5.585 | 5.730 | 4.826 |
| (ASTM D 412) | | | | | | | | | |
| Ult. Elongation, % | 408 | 76 | 33 | 75 | 501 | 138 | 48 | 38 | 79 |
| Tear Strength, kN/m | 39.8 | 30.8 | 27.7 | 26.4 | 57.4 | 45.0 | 42.7 | 41.2 | 35.7 |
| Puncture | 139 | 101 | 83 | 76 | 139 | 149 | 123 | 118 | 109 |
| Weld Strength on | 2.0 | 1.6 | 1.8 | 2.4 | 5.5 | 4.8 | 4.5 | 3.9 | 3.8 |
| Unaged Sheet, kN/m | | | | | | | | | |
| Properties. Aged | | | | | | | | | |
| Weld Strength on | 2.0 | 1.5 | 1.5 | * | 5.4 | 4.9 | 5.4 | 4.4 | 3.5 |
| Roof Aged Sheet, | | | | | | | | | |
| kN/m | | | | | | | | | |

| | 40 | 41 | 42 | 43 | 44 | 45 | 46 | 47 | 48 | 49 | 50 |
|---|---|---|---|---|---|---|---|---|---|---|---|
| Formulation (wt %) | | | | | | | | | | | |
| Endura ZH6775 | 45 | 45 | 45 | 45 | 45 | 45 | 45 | 45 | 45 | 45 | 45 |
| Lancer ESC12427 | 7 | 7 | 7 | 7 | 7 | 7 | 7 | 7 | 7 | 7 | 7 |
| Lancer ESC91234 | 3 | 3 | 3 | 3 | 3 | 3 | 3 | 3 | 3 | 3 | 3 |
| Vyram 9201-65 | 35 | 45 | 0 | 5 | 10 | 15 | 25 | 35 | 45 | 10 | 10 |
| Exact 0201 | | | | | | | | | | | 35 |
| Hifax CA10A | 10 | 0 | 45 | 40 | 35 | 30 | 20 | 10 | 0 | 35 | |
| Total | 100 | 100 | 100 | 100 | 100 | 100 | 100 | 100 | 100 | 100 | 100 |
| Physical | | | | | | | | | | | |
| Properties, Unaged | | | | | | | | | | | |
| 100% Modulus, Mpa | 3.971 | 3.613 | 6.295 | 5.578 | 3.509 | 5.261 | 4.537 | 3.971 | 3.509 | 3.496 | 6.288 |
| (ASTM D 412) | | | | | | | | | | | |
| Tens. Strength, Mpa | 5.012 | 3.599 | 10.287 | 9.184 | 7.474 | 7.867 | 5.385 | 4.668 | 3.537 | 7.336 | 13.624 |
| (ASTM D 412) | | | | | | | | | | | |
| Ult. Elongation, % | 382 | 156 | 600 | 588 | 797 | 535 | 384 | 353 | 157 | 489 | 681 |
| Tear Strength, kN/m | 32.2 | 27.8 | 53.6 | 53.4 | 51.8 | | 39.6 | 34.0 | 28.0 | | 47.3 |
| Puncture | 94 | 92 | 167 | 140 | 128 | 126 | 114 | 100 | 97 | 143 | 171 |
| Weld Strength on | 3.3 | 2.9 | 6.4 | 5.4 | 4.8 | 4.4 | 4.0 | 3.4 | 2.8 | 5.2 | 2.9 |
| Unaged Sheet, kN/m | | | | | | | | | | | |
| Properties. Aged | | | | | | | | | | | |
| Weld Strength on | 2.8 | 2.2 | 6.1 | 5.5 | 5.3 | 5.0 | 4.3 | 3.5 | 2.0 | 5.0 | 3.0 |
| Roof Aged Sheet, | | | | | | | | | | | |
| kN/m | | | | | | | | | | | |

* Roll anomaly - could not be tested due to severe pitted surface inconsistencies

We claim:

1. A thermoplastic sheet comprising:
a) from 5 to 98.5 wt % of an essentially uncross-linked, random ethylene copolymer having from 20 wt % to 90 wt % repeat units from ethylene and from 10 wt % to 80 wt % of repeat units from one or more other ethylenically unsaturated monomers based upon the weight of the random ethylene polymer;
b) from 0.3 to 83.5 wt % of a polypropylene-based crystalline thermoplastic; and
c) from 0.3 to 24.5 wt % of a vulcanized rubber.

2. The sheet of claim 1 wherein said polypropylene component b) is selected from the group consisting of an impact copolymer, a propylene homopolymer, and blends thereof.

3. The sheet of claim 2 wherein said polypropylene component b) additionally comprises a propylene α-olefin copolymer having an isotacetic or syndiotacetic polypropylene crystallinity of from 2% to 65% as measured by DSC.

4. The sheet of claim 1 wherein the vulcanized rubber particles are derived from one or more of the group consisting of elastomeric ethylene α-olefin polymers, butyl rubber, natural rubber, styrene-butadiene copolymer rubber, butadiene rubber, acrylonitrile rubber, halogenated rubber such as brominated and chlorinated isobutylene-isoprene copolymer rubber, butadiene-styrene-vinyl pyridine rubber, urethane rubber, polyisoprene rubber, epichlolorohydrine terpolymer rubber, polychloroprene, and mixtures thereof.

5. The sheet of claim 4 wherein the random ethylene copolymer a) is an ethylene/C₄ to C₂₀ α-olefin copolymer.

6. The sheet of claim 5 wherein said copolymer a) has a density of from 0.86 g/cm³ to 0.920 g/cm³ and molecular weight distribution of 1.5 to 3.5.

7. A sheet composition according claims 1, comprising from 29 wt % to 56.5 wt % of said a) uncross-linked, random ethylene, from 0.6 wt % to 29.5 wt % of said b) polypropylene-based thermoplastic, from 1.5 wt % to 14.5 wt % of said c) vulcanized rubber dispersed particle phase, and from 39.75 wt % to 49.6 wt % of said additives d).

8. The sheet of claim 1 having a thickness of 0.025 mm to 3.8 mm.

9. A roofing composite material comprising a plurality of thermoplastic membranes or sheets of claim 8 welded together.

10. The roofing composite material according to claim 7 having a weld quotient less than or equal to 1.3.

11. A process for preparing the thermoplastic sheet of claim 1 comprising:
(a) combining
(i) from 5 wt % to 98.5 wt % of a random ethylene copolymer having from 20 wt % to 90 wt % repeat units from ethylene and from 10 wt % to 80 wt % of repeat units from one or more other ethylenically unsaturated monomers based upon the weight of the random ethylene polymer,
(ii) from 1 wt % to 42 wt % of a thermoplastic elastomer having a polypropylene thermoplastic phase and a vulcanized rubber; and
(iii) from 0 wt % to 50 wt % of an additional polypropylene component selected from one or more of the group consisting of crystalline polypropylene homopolymer, impact copolymer polypropylene, propylene α-olefin copolymers having an isotacetic polypropylene crystallinity of from 2 to 65% as measured by DSC;
(b) melt processing the blend of (a) at a temperature higher than the melting temperature of the polypropylene;
(c) extruding the melt processed blend of (b) as a thermoplastic sheet.

12. The process of claim 11 wherein the thermoplastic elastomer (ii) comprises from 15 wt % to 90 wt % of the vulcanized rubber dispersed phase and from 10 wt % to 85 wt % of said polypropylene thermoplastic phase, said weight percents based upon the total weight of rubber plus thermoplastic excluding additives.

13. The process of claim 11 wherein the random ethylene copolymer a) i) is an ethylene/C₄ to C₂₀ α-olefin copolymer having a density of from 0.86 to 0.920 g/cm³, melt index (ASTM-D 1238, 2.16 kg, 190° C.) of 1.0 to 30 and molecular weight distribution of 1.5 to 3.5.

14. The process of claim 13 wherein up to 50 wt % of the random ethylene copolymer a) i) is replaced with an ethylene-propylene rubber having a density of 0.85 to 0.88 g/cm³ and a number average MW of 20,000-350,000 Daltons.

15. A process for preparing the thermoplastic sheet of claim 1 comprising:
(a) combining
(i) from 5.0 wt % to 98.5 wt % of a random ethylene polymer essentially incapable of cross-linking in the presence of the crosslinking agent of step (b) and having from 20 wt % to 90 wt % repeat units from ethylene and from 10 wt % to 80 wt % of repeat units from one or more other ethylenically unsaturated monomers based upon the weight of the random ethylene polymer,
(ii) from 0.35 wt % to 83.5 wt % of a polypropylene component, and
(iii) from 0.3 wt % to abut 24.5 wt % of an uncured rubber component capable of cross-linking in the presence of the cross-linking agent of step (b);
(b) melt processing the blend of (a) at a temperature higher than the melting temperature of the polypropylene component (ii) in the presence of a cross-linking agent to form a thermoplastic composition containing a dispersed vulcanized rubber particle phase;
(c) extruding the melt processed blend of (b) as a thermoplastic sheet.

16. The process of claim 15 wherein the uncured rubber component (iii) is selected from the group consisting of elastomeric ethylene α-olefin polymers, butyl rubber, natural rubber, styrene-butadiene copolymer rubber, butadiene rubber, acrylonitrile rubber, halogenated rubber such as brominated and chlorinated isobutylene-isoprene copolymer rubber, butadiene-styrene-vinyl pyridine rubber, urethane rubber, polyisoprene rubber, epichlolorohydrine terpolymer rubber, polychloroprene, and mixtures thereof.

17. The process of claim 15 comprising combining a propylene α-olefin copolymer having isotacetic polypropylene crystallinity from 2 to 65% as measured by DSC with the components as recited in step (a) and blending the resulting combination as recited in step (b).

18. The process of claims 15 wherein the random ethylene copolymer a) i) is an ethylene/C₄ to C₂₀ α-olefin copolymer having a density of from 0.86 g/cm³ to 0.920 g/cm³ and molecular weight distribution of 1.5 to 3.5.

19. The process of claim 18 wherein up to 50 wt % of the random ethylene copolymer a) i) is replaced with an ethylene-propylene rubber having a density of 0.85 to 0.88 g/cm³ and a number average MW of 20,000 to 350,000 Daltons.

20. A thermoplastic membrane comprising at least two welded sheets, wherein at least one of the two welded sheets comprises:
a) from 5 to 98.5 wt % of an essentially uncross-linked, random ethylene copolymer having from 20 wt % to 90 wt % repeat units from ethylene and from 10 wt % to 80 wt % of repeat units from one or more other ethylenically unsaturated monomers based upon the weight of the random ethylene polymer;
b) from 0.3 to 83.5 wt % of a polypropylene-based crystalline thermoplastic; and
c) from 0.3 to 24.5 wt % of a vulcanized rubber.
